(19) United States
(12) Patent Application Publication
(10) Pub. No.: US 2025/0211339 A1
(43) Pub. Date: Jun. 26, 2025

(54) A Two-Dimensional Discrete Fourier Transform Hardware Accelerator

(71) Applicant: Agency for Science, Technology and Research, Singapore (SG)

(72) Inventors: Kok Hin Teng, Singapore (SG); Salahuddin Raju, Innovis (SG); Di Zhu, Innovis (SG); Lay Keng Jayce Lim, Innovis (SG); Tshun Chuan Kevin Chai, Innovis (SG)

(21) Appl. No.: 18/847,662

(22) PCT Filed: Mar. 7, 2023
(86) PCT No.: PCT/SG2023/050140

§ 371 Date: Sep. 16, 2024

(30) Foreign Application Priority Data
Mar. 21, 2022 (SG) 10202202841R

(51) Int. Cl. H04B 11/00

(52) U.S. Cl. CPC H04B 11/00

(57) ABSTRACT

This document describes a two-dimensional discrete Fourier transform (DFT) hardware accelerator comprising an ultrasonic transmitter configured to convert input signals to I/Q ultrasonic waves which are then transmitted to a lens, and an ultrasonic receiver configured to receive and convert ultrasonic waves to baseband signals, whereby the lens is provided between the transmitter and the receiver, and whereby the I/Q ultrasonic waves transmitted by the transmitter will superimpose on the lens before being received by the receiver.

### FIELD OF THE INVENTION

This invention relates to a two-dimensional discrete Fourier transform (DFT) hardware accelerator comprising an ultrasonic transmitter configured to convert input signals to I/Q ultrasonic waves which are then transmitted to a lens, and an ultrasonic receiver configured to receive and convert ultrasonic waves to baseband signals, whereby the lens is provided between the transmitter and the receiver, and whereby the I/Q ultrasonic waves transmitted by the transmitter will superimpose on the lens before being received by the receiver.

### SUMMARY OF THE PRIOR ART

Machine learning models such as convolutional neural networks (CNNs) can be used for a variety of applications such as the classification of objects, natural language processing, synthetic-aperture radar or the processing and segmenting of images. However, increasingly sophisticated applications may require increasingly bigger and more complicated CNN models. Such models will need more computational resources and time for training and inference tasks.

Two-dimensional discrete Fourier transform (2-D DFT) is extensively used for transforming 2-dimensional spatial space signal to a frequency domain signal for analysis in digital signal processing and has been widely employed in CNNs for these purposes. In addition, in optical camera communication, 2-D DFT has been used in Orthogonal Frequency Division Multiplexing (OFDM) for screen system analysis, e.g., dynamic colour QR code. When large amounts of raw data are to be processed in real time, conventional fast Fourier transform (FFT) with 2D computation complexity of O(N² log 2N) becomes a bottleneck.

An ultrasonic wavefront framework for Fourier transform (FT) has been proposed and experimented recently with the 2D FT computation of O(N). However, the framework concept is proved by using software simulations or single pixel transducer probing. Without obtaining measurements of actual semiconductor on-chip transmitter (TX) and receiver (RX) pixel arrays, the accuracy of complex-valued 2D-DFT, wave propagation delay, maximum throughput achievable, and link budget are undetermined. The complex-valued dataset with amplitude and phase information included is not only require in OFDM applications but also for CNN implementation for better performance in image enhancement, denoising, and feature extraction.

For those above reasons, those skilled in the art are constantly striving to come up with a 2-D DFT hardware accelerator that does not have the bottleneck caused by the computation complexity of O(N² log 2N) but instead has the simpler computational complexity of O(N) in a small and compact hardware solution.

### SUMMARY OF THE INVENTION

The above and other problems are solved and an advance in the art is made by systems and methods provided by embodiments in accordance with the invention.

A first advantage of embodiments of a 2-D DFT hardware accelerator and methods of using the accelerator in accordance with the invention is that the accelerator is able to harness the physics of wave propagation diffraction to perform Fourier transform effectively. By doing so, the complexity of the computation process is improved from a FFT that has a computation complexity of O(N² log 2N) to a computation complexity of O(N).

A second advantage of embodiments of a 2-D DFT hardware accelerator and methods of using the accelerator in accordance with the invention is that the overall size of the accelerator is relatively small and as such, allows the accelerator to be easily integrated into existing system on chips.

The above advantages are provided by embodiments of a device or method in accordance with the invention operating in the following manner.

According to a first aspect of the invention, a two-dimensional discrete Fourier transform hardware accelerator is disclosed, the hardware accelerator comprising: an ultrasonic transmitter comprising: an input data interface block configured to receive input and control signals; a memory module configured to receive and store input signals from the input data interface block and based on the control signals, to selectively provide the input signals to an array of transmitter pixels, whereby each transmitter pixel comprises a I path modulation block that is provided with a first set of quadrature phase carrier signals, and a Q path modulation block that is provided with a second set of quadrature phase carrier signals, and whereby the array of transmitter pixels is configured to transmit to a lens provided between the ultrasonic transmitter and an ultrasonic receiver, ultrasonic waves generated by the I and Q path modulation blocks based on the input signals and the first and second sets of quadrature phase carrier signals; the ultrasonic receiver comprising: an array of receiver pixels, whereby each receiver pixel comprises an IQ demodulator that is provided with a third and a fourth set of quadrature phase carrier signals, and whereby each receiver pixel is configured to use the IQ demodulator in each receiver pixel to down convert ultrasonic waves received from the lens to I and Q baseband signals based on the third and fourth sets of quadrature phase carrier signals; a plurality of analog baseband and analog-to-digital converter (ADC) pairs configured to convert the I and Q baseband signals received from the receiver pixels to digital representations.

In accordance with embodiments of the first aspect of the invention, the ultrasonic receiver further comprises: a controller configured to delay the down conversion of the ultrasonic waves by the array of receiver pixels by a diagonal propagation delay t_{prop_DL} whereby the diagonal propagation delay t_{prop_DL} is computed based on a diagonal length between the array of transmitter pixels and the array of receiver pixels and a speed of the ultrasonic waves traveling between the ultrasonic transmitter and ultrasonic receiver.

In accordance with embodiments of the first aspect of the invention, the hardware accelerator further comprises a clock generator configured to generate the first, second, third and fourth sets of quadrature phase carrier signals such that the first set of quadrature phase carrier signals is in-phase with the third set of quadrature phase carrier signals and the second set of quadrature phase carrier signals is in-phase with the fourth set of quadrature phase carrier signals.

In accordance with embodiments of the first aspect of the invention, each I path modulation block comprises: a multiplexer configured to receive the first set of quadrature phase carrier signals and the input signal from the memory module; an I-driver configured to generate a modulated signal based on the input signal and the first set of quadrature phase carrier signals received from the multiplexer; and a transducer configured to generate and transmit ultrasonic waves based on the modulated signal generated by the I-driver.

In accordance with embodiments of the first aspect of the invention, each Q path modulation block comprises: a multiplexer configured to receive the second set of quadrature phase carrier signals and the input signal from the memory module; a Q-driver configured to generate a modulated signal based on the input signal and the second set of quadrature phase carrier signals received from the multiplexer; and a transducer configured to generate and transmit ultrasonic waves based on the modulated signal generated by the Q-driver.

In accordance with embodiments of the first aspect of the invention, each I path modulation block comprises: a multiplexer configured to receive the first set of quadrature phase carrier signals and the input signal from the memory module; a plurality of I-driver and transducer pairs, whereby each I-driver is configured to generate a modulated signal based on the input signal and the first set of quadrature phase carrier signals received from the multiplexer and each transducer is configured to generate and transmit ultrasonic waves based on the modulated signal generated by the I-driver.

In accordance with embodiments of the first aspect of the invention, each Q path modulation block comprises: a multiplexer configured to receive the second set of quadrature phase carrier signals and the input signal from the memory module; a plurality of Q-driver and transducer pairs, whereby each Q-driver is configured to generate a modulated signal based on the input signal and the first set of quadrature phase carrier signals received from the multiplexer and each transducer is configured to generate and transmit ultrasonic waves based on the modulated signal generated by the Q-driver.

In accordance with embodiments of the first aspect of the invention, a size of each transducer in each I-driver transducer pair is dependent on a gain of the I-driver.

In accordance with embodiments of the first aspect of the invention, a size of each transducer in each Q-driver transducer pair is dependent on a gain of the Q-driver.

In accordance with embodiments of the first aspect of the invention, each IQ demodulator comprises: a transducer to receive ultrasonic waves from the lens and to convert the ultrasonic waves to received signals; a first double-balanced mixer configured to down convert the received signals from the transducer to differential I baseband signals using the third set of quadrature phase carrier signals; a second double-balanced mixer configured to down convert the received signals from the transducer to differential Q baseband signals using the fourth set of quadrature phase carrier signals; a differential multiplexer configured to combine the differential I and Q baseband signals and to provide the combined differential I and Q baseband signals to a low pass filter that is configured to provide the filtered signals to the plurality of analog baseband and ADC pairs.

In accordance with embodiments of the first aspect of the invention, each IQ demodulator further comprises a low noise amplifier (LNA) that is provided between and output of the transducer and the inputs of the first and second double-balanced mixers.

In accordance with embodiments of the first aspect of the invention, the plurality of analog baseband and ADC pairs comprises a N number of analog baseband and ADC pairs and the array of receiver pixels comprises a N×N array of receiver pixels, whereby each row of the N×N array of receiver pixels are connected to one of the N number of analog baseband and ADC pairs, and the controller being configured to employ a time multiplexing technique to control the conversion of the I and Q baseband signals received from the receiver pixels to digital representations by each of the N number of analog baseband and ADC pairs.

In accordance with embodiments of the first aspect of the invention, the ultrasonic waves received from the lens by the array of receiver pixels comprises Fourier transform waves formed when ultrasonic waves transmitted from the transmitter superimposed at the lens constructively and destructively.

According to a second aspect of the invention, a method for performing two-dimensional discrete Fourier transformation using a hardware accelerator that comprises of an ultrasonic transmitter, an ultrasonic receiver and a lens provided between the ultrasonic transmitter and the ultrasonic receiver is disclosed, the method comprising: receiving, using the ultrasonic transmitter, input and control signals; receiving and storing, using the ultrasonic transmitter, input signals from the input data interface block and selectively providing, based on the control signals, the input signals to an array of transmitter pixels, whereby each transmitter pixel comprises a I path modulation block that is provided with a first set of quadrature phase carrier signals, and a Q path modulation block that is provided with a second set of quadrature phase carrier signals; transmitting to the lens, using the array of transmitter pixels, ultrasonic waves generated by the I and Q path modulation blocks based on the input signals and the first and second sets of quadrature phase carrier signals; down-converting, using an array of receiver pixels provided within the ultrasonic receiver, ultrasonic waves received from the lens to I and Q baseband signals based on third and fourth sets of quadrature phase carrier signals, whereby each receiver pixel comprises an IQ demodulator that is provided with the third and the fourth set of quadrature phase carrier signals; converting, using the ultrasonic receiver, the I and Q baseband signals received from the receiver pixels to digital representations.

In accordance with embodiments of the second aspect of the invention, the method further comprises the step of delaying, using the ultrasonic receiver, the down conversion of the ultrasonic waves by the array of receiver pixels by a diagonal propagation delay t_{prop_DL} whereby the diagonal propagation delay t_{prop_DL} is computed based on a diagonal length between the array of transmitter pixels and the array of receiver pixels and a speed of the ultrasonic waves traveling between the ultrasonic transmitter and ultrasonic receiver.

In accordance with embodiments of the second aspect of the invention, the method further comprises: generating, using a clock generator that is communicatively connected to the ultrasonic transmitter and receiver, the first, second, third and fourth sets of quadrature phase carrier signals such that the first set of quadrature phase carrier signals is in-phase with the third set of quadrature phase carrier signals and the second set of quadrature phase carrier signals is in-phase with the fourth set of quadrature phase carrier signals.

In accordance with embodiments of the second aspect of the invention, each I path modulation block comprises a multiplexer, an I-driver and a transducer, the method comprising the steps of: receiving, using the multiplexer, the first set of quadrature phase carrier signals and the input signal; generating, using the I-driver, a modulated signal based on the input signal and the first set of quadrature phase carrier signals received from the multiplexer; and generating and transmitting, using the transducer, ultrasonic waves based on the modulated signal generated by the I-driver.

In accordance with embodiments of the second aspect of the invention, each Q path modulation block comprises a multiplexer, a Q-driver and a transducer, the method comprising the steps of: receiving, using the multiplexer, the second set of quadrature phase carrier signals and the input signal; generating, using the Q-driver, a modulated signal based on the input signal and the second set of quadrature phase carrier signals received from the multiplexer; and generating and transmitting, using the transducer, ultrasonic waves based on the modulated signal generated by the Q-driver.

In accordance with embodiments of the second aspect of the invention, each IQ demodulator comprises a transducer, a first and a second double-balanced mixer and a differential multiplexer, the method comprising the steps of: receiving, using the transducer, ultrasonic waves from the lens and converting the ultrasonic waves to received signals; down-converting, using the first double-balanced mixer, the received signals from the transducer to differential I baseband signals using the third set of quadrature phase carrier signals; down-converting, using the second double-balanced mixer, the received signals from the transducer to differential Q baseband signals using the fourth set of quadrature phase carrier signals; combining, using the differential multiplexer, the differential I and Q baseband signals and providing the combined differential I and Q baseband signals to a low pass filter; and providing, using the low pass filter, the filtered signals to the plurality of analog baseband and ADC pairs.

According to a third aspect of the invention, a two-dimensional discrete Fourier transform sub-system is disclosed, the sub-system comprising: a transmitter block comprising: an input data interface block configured to receive input and control signals; a memory module configured to receive and store input signals from the input data interface block and based on the control signals, to selectively provide the input signals to an array of transmitter pixels, whereby each transmitter pixel comprises a I path modulation block that is provided with a first set of quadrature phase carrier signals, and a Q path modulation block that is provided with a second set of quadrature phase carrier signals, and whereby the array of transmitter pixels is configured to transmit to a lens provided between the transmitter block and a receiver block, ultrasonic waves generated by the I and Q path modulation blocks based on the input signals and the first and second sets of quadrature phase carrier signals; the receiver block comprising: an array of receiver pixels, whereby each receiver pixel comprises an IQ demodulator that is provided with a third and a fourth set of quadrature phase carrier signals, and whereby each receiver pixel is configured to use the IQ demodulator in each receiver pixel to down convert ultrasonic waves received from the lens to I and Q baseband signals based on the third and fourth sets of quadrature phase carrier signals; a plurality of analog baseband and analog-to-digital converter (ADC) pairs configured to convert the I and Q baseband signals received from the receiver pixels to digital representations.

### BRIEF DESCRIPTION OF THE DRAWINGS

The above advantages and features in accordance with this invention are described in the following detailed description and are shown in the following drawings:

FIG. 1 illustrating a system representative of modules of a 2-D DFT hardware accelerator in accordance with embodiments of the invention;

FIG. 2 illustrating a schematic of a transmitter pixel of the 2-D DFT hardware accelerator in accordance with embodiments of the invention;

FIG. 3 illustrating a flowchart of a process for transmitting an ultrasonic wave by an array of transmitter pixels in accordance with embodiments of the invention;

FIG. 4 illustrating a schematic of a receiver pixel of the 2-D DFT hardware accelerator in accordance with embodiments of the invention;

FIG. 5 illustrating a flowchart of a process for receiving an ultrasonic wave by an array of receiver pixels in accordance with an embodiment of the invention; and

FIG. 6 illustrating a wave containing a propagation delay when the wave is transmitted from the array of transmitter pixels to the array of receiver pixels.

### DETAILED DESCRIPTION

This invention relates to a two-dimensional discrete Fourier transform (DFT) hardware accelerator comprising an ultrasonic transmitter configured to convert input signals to I/Q ultrasonic waves which are then transmitted to a lens, and an ultrasonic receiver configured to receive and convert ultrasonic waves to baseband signals, whereby the lens is provided between the transmitter and the receiver, and whereby the I/Q ultrasonic waves transmitted by the transmitter will superimpose on the lens before being received by the receiver.

In general, the ultrasonic transmitter is configured to modulate input data with high frequency carrier signals. The modulated signal is then used to drive transducers, which produce ultrasonic waves through mechanical vibrations. The ultrasonic waves superimpose with each other and create constructive or destructive interference (wavefronts). These wavefronts when propagated through a lens will decompose into their frequency components (Fourier transform) and can measured by the receiver.

The ultrasonic receiver is then configured to recover the DFT data for post-processing. The receiver does so by first receiving the FT waves then converts the received FT waves to electrical signals using transducers. The electrical signals are subsequently down converted to DC/low intermediate frequency (IF) signals before the down converted signals are digitized. One skilled in the art will recognize that the transmitter and receiver disclosed herein are not limited for use in the generation of 2D-FT ultrasonic waves and may also be used in the generation of other types of 2D-FT waves.

One skilled in the art will recognize that many functional units in this description have been labelled as modules or blocks throughout the specification. The person skilled in the art will also recognize that a module or a block may be implemented as circuits, logic chips or any sort of discrete component. The choice of the implementation of the modules or blocks is left as a design choice to a person skilled in the art and does not limit the scope of this invention in any way.

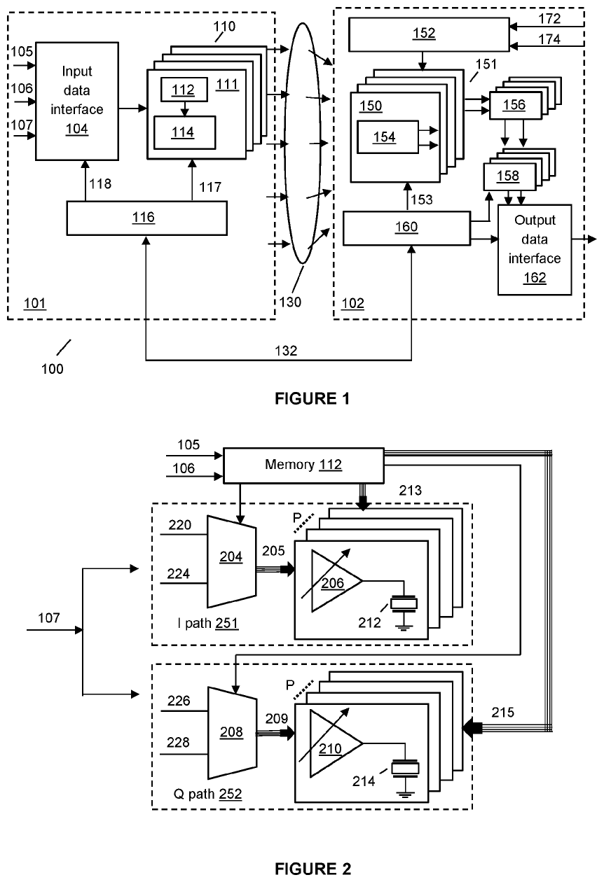

FIG. 1 illustrates system 100 that is representative of modules of a 2-D DFT hardware accelerator in accordance with embodiments of the invention. In general, ultrasonic transmitter 101 is configured to transmit modulated ultrasonic waves to ultrasonic receiver 102 through lens 130 whereby receiver 102 is configured to recover FT information from the received ultrasonic waves and subsequently digitize the received signals for post-processing. As the ultrasonic waves propagate through lens 130, the waves naturally diffract to form a 2D-FT wave pattern.

Ultrasonic transmitter 101 comprises an input data interface block 104 that is configured to receive input data signals 105, and control signals 106 and 107; an array of transmitter pixels 110 whereby each transmitter pixel 111 in array 110 comprises a memory 112 and a modulation block 114; and a clock generator 116 to drive input data interface block 104 and the array of transmitter pixels 110.

Through the use of the modules shown in FIG. 1, ultrasonic transmitter is configured to modulate input data 105 received at interface block 104 (i.e., input data 105 may comprise, but is not limited to, P bits of data symbol, D_{IN}[P+1:0]) with a high frequency carrier signal to form a modulated signal having amplitude and phase values. A low frequency clock signal 118 generated by clock generator 116 may be used to drive interface block 104.

Control signal 106 may comprise a “Ready” signal which indicates whether input data 105 may be loaded into memory 112 of the respective transmitter pixels in array 110 and control signal 107 may comprise a “TX_Act” signal that is used to indicate the completion of the loading of input data into memory 112 of the respective transmitter pixels, and that the respective modulation blocks 114 of array 110 may then be activated to begin the conversion and transmission processes.

In accordance with embodiments of the invention, the modulation of the input signal with the high frequency carrier signals takes place at the array of transmitter pixels 110. Interface block 104 is configured to provide input data 105, control signals 106 and 107, and high frequency carrier signal 118 to the array of transmitter pixels 110.

The array of transmitter pixels 110 may comprise N×N transmitter pixels 111 which are configured to generate and transmit a 2D-ultrasonic wave, where the value of N is defined as N>1. In particular, each of the transmitter pixels 111 in array 110 are configured to modulate input data 105 stored in memory 112 with quadrature phase high frequency carrier signals using I and Q path modulation blocks (see FIG. 2) to generate modulated signals having phase and amplitude domains or values and this is done through an up-conversion process.

In accordance with embodiments of the invention, the modulation process may be defined as I cos(ωt)+Q sin(ωt)=A cos(ωt+φ), where

$$A = \sqrt{{I}^{2} + {Q}^{2}} ,$$

$$φ = {tan}^{- 1} ( \frac{I}{Q} ) ,$$

where I is defined as the signal amplitude of the I path, Q is defined as the signal amplitude of the Q path, and w is defined as the angular speed of the carrier signal.

In addition to generating low frequency clock signal 118 to drive interface block 104, clock generator 116 may also be configured to generate and to provide four high frequency quadrature phase clock signals 117 to each of transmitter pixels 111 in transmitter array 110. In embodiments of the invention, high frequency quadrature phase clock signals 117 may comprise a first high frequency clock signal that has a 0° phase angle, a second high frequency clock signal that has a 900 phase angle, a third high frequency clock signal that has a 180° phase angle, and a fourth high frequency clock signal that has a 270° phase angle.

In embodiments of the invention, clock generator 116 may comprise, but is not limited to, a clock source and a quadrature phase generator. The clock source may be a phase-locked loop, delay-locked loop, or any other type of frequency synthesizer and the quadrature phase generator may comprise a polyphase filter, a digital phase splitter, or any other types of quadrature phase devices. In embodiments of the invention, a clean jitter clock reference (REF CLK) which can be generated from a crystal oscillator or other noiseless clock sources may be provided within or provided to clock generator 116.

The modulated signals obtained from each of the I and Q path modulation blocks are then used to drive transducers provided at each of the I and Q path modulation blocks and may comprise, but is not limited to, a Piezoelectric Micromachined Ultrasonic Transducer (PMUT) to convert the modulated signals into ultrasonic waves which are then transmitted to lens 130.

The transmitted ultrasonic waves naturally form wavefronts (i.e., summation of the different waves) at a distance from the pixel. The lens may comprise, but is not limited to, a Fresnel lens or a Metalens, provides “curvatures” which bend the incident (at the surface of the lens) wavefronts and focuses the resultant waves at a focal distance. As the incident wavefronts comprise superimposed waves, the curvature of the lens provides different degrees of bending. Hence, the resulting “image” formed at the focal distance from the lens (where the receivers are) will contain the spatial frequency components of the input data that was transmitted.

In accordance with embodiments of the invention, after the ultrasonic waves have propagated through lens 130, the ultrasonic waves received at the ultrasonic receiver 102 will be the Fourier transform of the input data from 105.

Ultrasonic receiver 102 is configured to recover FT ultrasonic waves from lens 130 by first converting the ultrasonic waves to electrical signals though the use of transducers. These electrical signals are then down converted to direct current (DC)/intermediate frequency (IF) signals, i.e., baseband signals, before these baseband signals are digitized and send out off-chip for post-processing.

In embodiments of the invention, ultrasonic receiver 102 may comprise an array of receiver pixels 151 comprising N×N receiver pixels 150 whereby the array of receiver pixels 151 may be configured to receive 2D-FT ultrasonic waves propagated from lens 130. In order to recover complex-valued FT information, the received FT ultrasonic waves are then down converted to baseband signals using an IQ demodulator 154 (provided within receiver pixel 150) and using quadrature phase high frequency carrier signals 153 provided by clock generator 160. It should be noted that the frequency contents of the received FT ultrasonic waves at each pixel of 151 is different from the corresponding pixel at 110. However, the centre carrier frequency of the quadrature signals of 117 and 153 is the same.

Ultrasonic receiver 102 may also comprise a plurality of analogue baseband processing 156 and analogue-to-digital (ADC) 158 pairs. Analog baseband processing 156 is configured to provide a fix or programmable gain to baseband signals generated by the array of receiver pixels 151 and may comprise, but is not limited to, single amplifier designs, multiple amplifier designs, or designs employing a voltage gain amplifier (VGA) or multiple VGAs and anti-aliasing filters. Analog-to-digital (ADC) 156 is then employed to convert the I and Q baseband signals, i.e., the demodulated signals, that have been amplified by analogue baseband 156 to their digital representations. The digital data may then be communicated off-chip through output data interface 162. In embodiments of the invention, interface 162 may comprise a parallel-to-series converter to parallelly store analogue-to-digital converted output data to a memory buffer and to serially output data for post-processing. The complex valued FT information can then be recovered in off-chip digital baseband for further application use like edge detection or filtering. The disclosure can also perform inverse DFT to recover the original input signal by passing the FT signal from the receiver side 102 as the inputs 105 of the transmitter 101 and repeating the same procedure as before when perform DFT.

In further embodiments of the invention, a controller 152 may be provided within receiver 102. Controller 152 may be configured to activate the array of receiver pixels 151, and through the use of other sub-blocks provided within ultrasonic receiver 102, control the transmission of the IQ baseband signals from the array of receiver pixels 151 to the analogue baseband 156 and ADC 158 pairs, and selectively power down specific sub-blocks within ultrasonic receiver 102 as required. While controller 152 provides selective control to activate all or parts of the array of receiver pixels 151, a RX_ACK 172 signal is used to activate the signal acquisition process of the array of receiver pixels 151. Once the signal acquisition process is completed, signal OE_IN 174 then activates the streaming of the output data from output data interface 162.

Clock generator 160 may be similar as clock generator 116. In other words, clock generator 160 may also comprise, but is not limited to, a clock source and a quadrature phase generator. Additionally, clock generator is configured to provide a low frequency clock signal to controller 152, data interface block 162, and ADC 158, and four high frequency quadrature phase clock signals to each of the receiver pixels 150. In embodiments of the invention, the high frequency quadrature phase clock signals may comprise a fifth high frequency clock signal that has a 0° phase angle, a sixth high frequency clock signal that has a 90° phase angle, a seventh high frequency clock signal that has a 180° phase angle, and an eighth high frequency clock signal that has a 270° phase angle. In other embodiments of the invention, both ultrasonic transmitter 101 and receiver 102 may share the same reference clock, and this may comprise, but is not limited to, a crystal oscillator or clock generator to avoid phase mismatches.

FIG. 2 illustrates a schematic of a transmitter pixel 111 of ultrasonic transmitter 101 in accordance with embodiments of the invention. Transmitter pixel 111 comprises memory 112 and modulation block 114 which is made up of I path module 251 and Q path module 252.

I path module 251 comprises multiplexer 204 which is configured to receive input data signals from memory 112 and a set of quadrature phase carrier signals comprising high frequency quadrature phase clock signals 220 and 224; and a plurality of I-driver 206 and transducer 212 pairs whereby each I-driver 206 is configured to generate an I modulated signal based on an input data signal and the set of quadrature phase carrier signals (as received from memory 112 via path 213, and from multiplexer 204 via path 205 respectively) and transducer 212 is configured to convert the modulated signals into ultrasonic waves which are then propagated towards lens 130.

The number of I-driver transducer pairs that are to be utilized in I path module 251 depends on the data symbol of the input data signal. For example, a P number of I-driver 206 and transducer 212 pairs will be provided within I path module 251 when the input data signals comprise P bits of data symbol. Correspondingly, paths 213 and 205 would each comprise a P number of paths respectively.

In a further embodiment of the invention, for each I-driver 206 and transducer 212 pair, the size of transducer 212 is dependent on the gain of I-driver 206. Further, the gain of each I-driver (in each I-driver transducer pair) may be determined based on the modulated signal that is to be generated by the I-driver transducer pair.

As for Q path module 252, this module comprises a multiplexer 208 which is configured to receive input data signals from memory 112 and a set of quadrature phase carrier signals comprising high frequency quadrature phase clock signals 226 and 228; a plurality of Q-driver 210 and transducer 214 pairs whereby each Q-driver 210 is configured to generate a Q modulated signal based on an input data signal and the set of quadrature phase carrier signals (as received from memory 112 via path 215, and from multiplexer 208 via path 209 respectively) and transducer 214 is configured to convert the modulated signals into ultrasonic waves which are then propagated towards lens 130.

Similar to that described above, the number of Q-driver transducer pairs that are to be utilized in Q path module 252 depends on the data symbol of the input data signal. For example, a P number of Q-driver 210 and transducer 214 pairs will be provided within Q path module 252 when the input data signals comprise P bits of data symbol. Correspondingly, paths 215 and 209 would each comprise a P number of paths respectively.

In a further embodiment of the invention, for each Q-driver 210 and transducer 214 pair, the size of transducer 214 is dependent on the gain of Q-driver 210. Further, the gain of each Q-driver (in each Q-driver transducer pair) may be determined based on the modulated signal that is to be generated by the Q-driver transducer pair.

In embodiments of the invention, high frequency quadrature phase clock signals 220 and 224 may comprise the first high frequency clock signal that has a 0° phase angle and the third high frequency clock signal that has a 180° phase angle and high frequency quadrature phase clock signals 226 and 228 may comprise the second high frequency clock signal that has a 90° phase angle and the fourth high frequency clock signal that has a 270° phase angle. One skilled in the art will recognize that high frequency quadrature phase clock signals may comprise other various combinations of high frequency clock signals without departing from this invention. It should also be noted that control signal 107 is provided to control both the I and Q path modules 251 and 252.

In embodiments of the invention, memory 112 may comprise a bank of memory cells that is embedded into each of transmitter pixels 111. Input data 105 will then only be written into memory 112 when the appropriate control signals 106 are received by the transmitter pixel 111. For example, input data 105 comprising P bits of data symbol, DIN[P−1:0] will only be written into memory 112 when control signals 106 comprising write signals COL_EN and WL_IQ are enabled (COL_EN=‘1’, WL_IQ=‘10’ for I Path or WL_IQ=‘01’ for Q Path). In embodiments of the invention, memory 112 may comprise a general memory device, which is not limited to static random-access memory (SRAM) cell or D-flip flop (DFF) registers. The advantage of employing memory cells that are embedded in each of transmitter pixel 111 is that this allows for the reuse of input data routing for each column of N transmitter pixels, thereby reducing the array size of the transmitter pixel.

For example, P-bits of input data routing can be shared with each column of N transmitter pixels respectively using a N number of WL_IQ [1:0] signals. In this case, instead of (N×P) routing paths for N transmitter pixels in a single column, only 9 routing paths are used for N transmitter pixels (under the assumption that the input data comprises 9 bits). In addition, by introducing a selection option for phase polarity, this creates a redundancy for transmission modulation. The advantage provided by this arrangement is that the linearity of the programmable transmitter strength through the driver is relaxed as the bit selection amplitude error in the I/Q output modulators are absorbed. Furthermore, it is not necessary for the modulated signals from the output modulators in the I and Q paths 251 and 252 respectively to be combined before the modulated signals are sent to transducers 212 and 214 as the transmitted ultrasonic waves superimpose with each other and create constructive or destructive interference (wavefronts) as these waves propagate through the lens. This approach avoids active/passive electrical signal combination devices being used, thereby reducing the size of transmitter pixel 111.

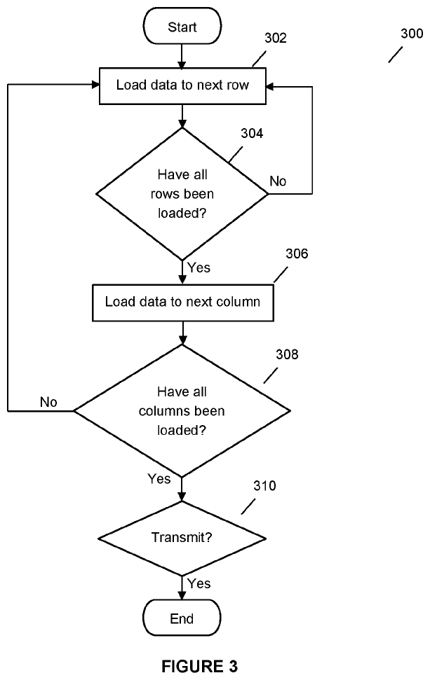

In embodiments of the invention, a process is needed for transmitting an ultrasonic wave by an array of transmitter pixels. The following description and FIG. 3 describe embodiments of processes as implemented in an N×N array of transmitter pixels when P bits of data symbol are to be converted to ultrasonic waves and transmitted in accordance with embodiments of this invention.

Process 300 begins at step 302 whereby input data is loaded into each transmitter pixel (in the pixel's memory cell) in a row of the array. Process 300 then determines at step 304 whether the input data has been loaded into all the rows of transmitter pixels in the array. If process 300 determines that the input data has not been loaded into all the rows of transmitter pixels in the array, process 300 then proceeds to step 302 whereby process 300 then loads input data into each transmitter pixel (in the pixel's memory cell) in the next row of the array. In other words, at steps 302 and 304, process 300 will load the input data into the memory of each transmitter pixel in a row-by-row sequence until the input data has been loaded into all the rows of transmitter pixels in the column.

In embodiments of the invention, as each transmitter pixel comprises I and Q paths 251 and 252, the amount of data that has to be loaded is 2*N when there are N rows of transmitter pixels. The processes at steps 302 and 304 will then repeat until 2*N data has been loaded for all the N rows of transmitter pixels.

Once this is done, process 300 then proceeds to step 306. At step 306, the input data will be loaded into a transmitter pixel at the next column. At step 308, process 300 determines whether all the transmitter pixels in the column have been loaded with the input data. If process 300 determines at step 308 that not all the transmitter pixels in the column have been loaded with the input data, process 300 then returns to step 302. Steps 302 to 304 will then repeat until all the input data has been loaded into the N rows of transmitter pixels in this column.

Once all the input data has been loaded into the N rows of transmitter pixels in this column, process 300 then proceeds to step 306. At step 306, the input data will be loaded into a transmitter pixel at another column. Process 300 then determines at step 308 whether all the transmitter pixels in the column has been loaded with the input data. If all the transmitter pixels in the column have not been loaded with the input data, process 300 will repeat steps 302-308. Conversely, when all the transmitter pixels in the column have been loaded with the input data, process 300 will proceed to step 310. At step 310, if process 300 has received the command to transmit, process 300 will cause the array of transmitter pixels to transmit the ultrasonic waves to the lens. Conversely, if the transmit command has not been received, process 300 will wait at this step until the command is received. Once the ultrasonic waves have been transmitted, process 300 then ends.

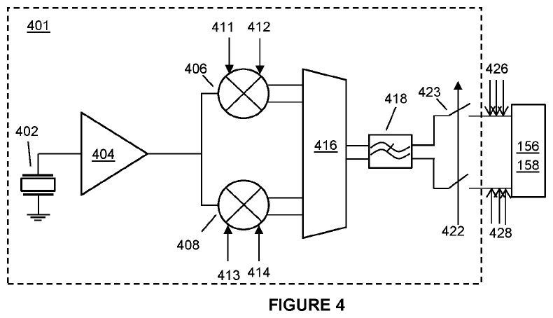

FIG. 4 illustrates a schematic of a receiver pixel of the ultrasonic receiver in accordance with embodiments of the invention. In general, receiver pixel 401 is configured as a direct conversion/low IF receiver architecture to down convert received ultrasonic signals to baseband signals. As illustrated in FIG. 4, receiver pixel 401 comprises a transducer 402, a low noise amplifier (LNA) 404, double-balanced mixers 406 and 408, differential multiplexer 424 and low pass filter 418.

Transducer 402 is configured to convert ultrasonic waves received from lens 130 into electrical signals. In embodiments of the invention, LNA 404 may be employed to amplify input electrical signal from transducer 402 to improve the sensitivity of the received signal. In addition to the single-ended LNA topology illustrated in FIG. 4, a differential topology may also be employed for LNA 404. If LNA 404 is not provided in the configuration of receiver pixel 401, an output from transducer 402 may be provided directly to double-balanced mixers 406 and 408. Double-balanced mixers 406 and 408 may comprise passive or active mixers and are used to down convert the received signals from transducer 402 to differential I baseband signals (in-phase orthogonal differential baseband signals) and to differential Q baseband signals (quadrature orthogonal differential baseband signals).

In embodiments of the invention, double-balanced mixer 406 down converts the received signals from transducer 402 to differential I baseband signals (in-phase orthogonal differential baseband signals) using a set of quadrature phase carrier signals comprising high frequency quadrature phase clock signals 411 and 412 and double-balanced mixer 408 down converts the received signals from transducer 402 to differential Q baseband signals (quadrature orthogonal differential baseband signals) using a set of quadrature phase carrier signals comprising high frequency quadrature phase clock signals 413 and 414. In embodiments of the invention, high frequency quadrature phase clock signals 411 and 412 may comprise the fifth high frequency clock signal that has a 0° phase angle and the seventh high frequency clock signal that has a 180° phase angle and high frequency quadrature phase clock signals 413 and 414 may comprise the sixth high frequency clock signal that has a 90° phase angle and the eighth high frequency clock signal that has a 270° phase angle. One skilled in the art will recognize that high frequency quadrature phase clock signals may comprise other various other combinations of high frequency clock signals without departing from this invention

The in-phase and quadrature orthogonal differential baseband signals from mixers 406 and 408 are then provided to differential multiplexer 416. Differential multiplexer 416, which comprises a 2-to-1 differential multiplexer, may then combine and share the outputs from mixers 406 or 408 with low-pass filter 418. The filtered signals from filter 418 are then provided to analogue baseband 156 and ADC 158 pairs. It should be noted that as receiver pixel 401 comprises only of a single low-pass filter, this allows the overall size of the pixel to be kept small. It should also be noted that the sequence in which the I and Q baseband signals are provided to analogue baseband 156 and ADC 158 pairs is not of particular importance. Instead, more importance is placed on the alignment of the output sequence across all of receiver pixels 401 in the array of receiver pixels 151.

In embodiments of the invention, a time multiplexing technique may be applied such that for a receiver pixel array having a N number of columns, the output of each receiver pixel in each row of the receiver pixel array may share a single analogue baseband 156 and ADC 158 pair. In such an embodiment, a switch 423 (which may comprise a CMOS switch) may be provided between the differential output of each receiver pixel's low pass filter and the analogue baseband 156 and ADC 158 pair. A selection signal 422 may then be used to control the switching of switch 423 so that each receiver pixel's differential output (from the low pass filter) from the M^{th} column, i.e., outputs 426 and 428, may be selectively provided to the analogue baseband and ADC pair. When such a technique is employed, M=1 and M should be ≤N. The advantage of doing this is that only a N number of analogue basebands and ADC pairs are required for a receiver pixel array comprising N×N pixels, thereby reducing the overall size of the ultrasonic receiver.

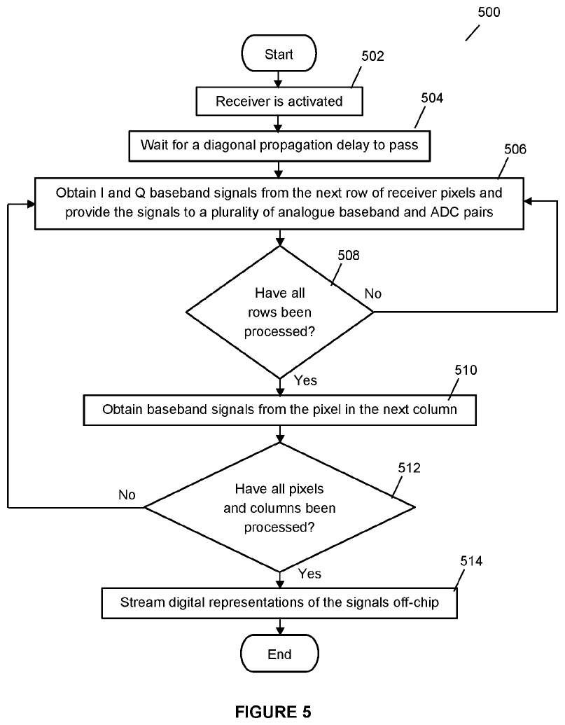

In embodiments of the invention, a process is needed for receiving an ultrasonic wave by an array of receiver pixels. The following description and FIG. 5 describe embodiments of processes as implemented in an ultrasonic receiver having an N×N array of receiver pixels in accordance with embodiments of this invention.

Process 500 begins at step 502 whereby when a transmitted signal is received, all the sub-blocks within the ultrasonic receiver, such as the array of receiver pixels, analogue baseband and ADC pairs will be activated by process 500. Process 500 will then cause a first column of a N number of receiver pixels to wait at step 504 until the received FT ultrasonic waves have settled before process 500 causes the I/Q baseband signals produced by a receiver pixel in this column to be provided to the analogue baseband and ADC pairs. In other words, process 500 will wait for the ultrasonic waves transmitted by the furthest transmitter pixel to be received first at step 504 before process 500 proceeds to the next step. The settling or waiting time at step 504 should be longer than a diagonal wave propagation delay as computed between the array of transmitter pixels to the array of receiver pixels.

Process 500 then proceeds to step 506 whereby I and Q baseband signals are obtained from the next row of receiver pixels. These baseband signals are then provided to a plurality of analogue baseband and ADC pairs which then in turn store these signals in a memory. At step 508, process 500 determines whether all the rows of receiver pixels in the first column have been processed and if not, process 500 returns to step 506 where I and Q baseband signals are obtained from the next row of receiver pixels and these baseband signals are provided signals to a plurality of analogue baseband and ADC pairs. Steps 506-508 repeat themselves until all the rows of receiver pixels in the first column have been processed by process 500. It should be noted that at this stage, there will be 2*N digital representations stored in the memory for the first column, whereby these 2*N representations represent I and Q baseband signals obtained from N rows of receiver pixels.

Once process 500 determines at step 508 that all the rows of receiver pixels in the first column have been processed, process 500 then proceeds to step 510. At step 510, process 500 will obtain I and Q baseband signals from a receiver pixel in the next column of receiver pixels in the array. Process 500 then proceeds to step 512. At this step, process 500 will determine if all the receiver pixels in this column have been processed and if not, this implies that the I and Q baseband signals from these receiver pixels have not yet been obtained. As such, process 500 will return to step 506 whereby I and Q baseband signals are obtained from the next row of receiver pixels and are provided to the plurality of analogue baseband and ADC pairs. Steps 506-512 repeat themselves until all the receiver pixels in the array have been processed by process 500. At this stage of process 500, 2*N*N digital representations would have been obtained and stored in the memory. Process 500 then streams this information off-chip at step 514 and process 500 ends.

In embodiments of the invention, when process 500 ends, the array of receiver pixels, analogue basebands, and ADCs will power down and the transmission of ultrasonic waves by the transmitter may be halted or a new batch of transmission may begin.

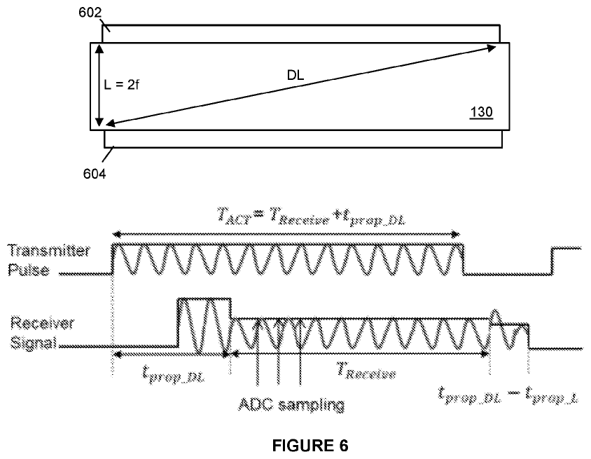

FIG. 6 illustrates a computation of a wave propagation delay value that occurs when an ultrasonic wave is transmitted from an array of transmitter pixels 602 and received by an array of receiver pixels 604. Under the assumption that a single transmitter or receiver pixel has an area of y μm×y μm, the area of an N×N array of transmitter/receiver pixels may then be defined as is (N*y)². As such, a diagonal length, DL, of a 3-D cube whose top and bottom surfaces are formed from the arrays of transmitter and receiver pixels respectively, may be defined as DL={square root over ((2*f)²+(2*(N*y)²))}, where f is half of the distance, L, between the array of transmitter pixels and the array of receiver pixels. Under the assumption that the speed of an ultrasonic wave that travels from the array of transmitter pixels to the array of receiver pixels is C_{sound}, a direct propagation delay may be defined as:
direct propagation delay,

$${t}_{prop \_ L} = \frac{L}{{C}_{sound}}$$

and, diagonal propagation delay may be defined as:
diagonal propagation delay,

$${t}_{prop \_ DL} = \frac{DL}{{C}_{sound}} = \frac{\sqrt{{( 2 * f )}^{2} + ( 2 * {( N * y )}^{2} )}}{{C}_{sound}} .$$

From the equations above, it can be seen that both propagation delay values t_{prop_L} and t_{prop_DL} may be obtained once the speed of the ultrasonic wave, C_{sound} is derived. In embodiments of the invention, this parameter may be obtained from measurement data. As the diagonal propagation delay t_{prop_DL} has a larger value than the direct propagation delay, t_{prop_L}, the ultrasonic receiver should only start the down conversion and digitization processes after the ultrasonic transmitter has transmitted the ultrasonic waves for a period equivalent to the diagonal propagation delay t_{prop_DL}.

FIG. 6 illustrates a pulse as transmitted by the array of transmitter pixels whereby the length of the actual transmission is T_{ACT}=T_{Receive}+t_{prop_DL} where T_{Receive} is defined as the amount of time that is required for the array of receiver pixels to receive and convert the ultrasonic waves into electrical signals. FIG. 6 also illustrates the signal as received by the array of receiver pixels whereby it can be seen that during the initial period defined by the diagonal propagation delay t_{prop_DL}, the received signal includes some distortion and as a result, the digitization of the received signal should only start after this initial period has lapsed.

The above is a description of embodiments of a device and method in accordance with the present invention as set forth in the following claims. It is envisioned that others may and will design alternatives that fall within the scope of the following claims.

1. A two-dimensional discrete Fourier transform hardware accelerator comprising:
an ultrasonic transmitter comprising:
an input data interface block configured to receive input and control signals;
a memory module configured to receive and store input signals from the input data interface block and based on the control signals, to selectively provide the input signals to an array of transmitter pixels,
whereby each transmitter pixel comprises a I path modulation block that is provided with a first set of quadrature phase carrier signals, and a Q path modulation block that is provided with a second set of quadrature phase carrier signals, and
whereby the array of transmitter pixels is configured to transmit to a lens provided between the ultrasonic transmitter and an ultrasonic receiver, ultrasonic waves generated by the I and Q path modulation blocks based on the input signals and the first and second sets of quadrature phase carrier signals;
the ultrasonic receiver comprising:
an array of receiver pixels, whereby each receiver pixel comprises an IQ demodulator that is provided with a third and a fourth set of quadrature phase carrier signals, and whereby each receiver pixel is configured to use the IQ demodulator in each receiver pixel to down convert ultrasonic waves received from the lens to I and Q baseband signals based on the third and fourth sets of quadrature phase carrier signals;
a plurality of analog baseband and analog-to-digital converter (ADC) pairs configured to convert the I and Q baseband signals received from the receiver pixels to digital representations.

2. The hardware accelerator according to claim 1, whereby the ultrasonic receiver further comprises:
a controller configured to delay the down conversion of the ultrasonic waves by the array of receiver pixels by a diagonal propagation delay t_{prop_DL} whereby the diagonal propagation delay t_{prop_DL} is computed based on a diagonal length between the array of transmitter pixels and the array of receiver pixels and a speed of the ultrasonic waves traveling between the ultrasonic transmitter and ultrasonic receiver.

3. The hardware accelerator according to claim 1, whereby the hardware accelerator further comprises a clock generator configured to generate the first, second, third and fourth sets of quadrature phase carrier signals such that the first set of quadrature phase carrier signals is in-phase with the third set of quadrature phase carrier signals and the second set of quadrature phase carrier signals is in-phase with the fourth set of quadrature phase carrier signals.

4. The hardware accelerator according to claim 1, whereby each I path modulation block comprises:
a multiplexer configured to receive the first set of quadrature phase carrier signals and the input signal from the memory module;
an I-driver configured to generate a modulated signal based on the input signal and the first set of quadrature phase carrier signals received from the multiplexer; and
a transducer configured to generate and transmit ultrasonic waves based on the modulated signal generated by the I-driver.

5. The hardware accelerator according to claim 1, whereby each Q path modulation block comprises:
a multiplexer configured to receive the second set of quadrature phase carrier signals and the input signal from the memory module;
a Q-driver configured to generate a modulated signal based on the input signal and the second set of quadrature phase carrier signals received from the multiplexer; and
a transducer configured to generate and transmit ultrasonic waves based on the modulated signal generated by the Q-driver.

6. The hardware accelerator according to claim 1, whereby each I path modulation block comprises:
a multiplexer configured to receive the first set of quadrature phase carrier signals and the input signal from the memory module;
a plurality of I-driver and transducer pairs, whereby each I-driver is configured to generate a modulated signal based on the input signal and the first set of quadrature phase carrier signals received from the multiplexer and each transducer is configured to generate and transmit ultrasonic waves based on the modulated signal generated by the I-driver.

7. The hardware accelerator according to claim 1, whereby each Q path modulation block comprises:
a multiplexer configured to receive the second set of quadrature phase carrier signals and the input signal from the memory module;
a plurality of Q-driver and transducer pairs, whereby each Q-driver is configured to generate a modulated signal based on the input signal and the first set of quadrature phase carrier signals received from the multiplexer and each transducer is configured to generate and transmit ultrasonic waves based on the modulated signal generated by the Q-driver.

8. The hardware accelerator according to claim 6, whereby a size of each transducer in each I-driver transducer pair is dependent on a gain of the I-driver.

9. The hardware accelerator according to claim 7, whereby a size of each transducer in each Q-driver transducer pair is dependent on a gain of the Q-driver.

10. The hardware accelerator according to claim 1, whereby each IQ demodulator comprises:
a transducer to receive ultrasonic waves from the lens and to convert the ultrasonic waves to received signals;
a first double-balanced mixer configured to down convert the received signals from the transducer to differential I baseband signals using the third set of quadrature phase carrier signals;
a second double-balanced mixer configured to down convert the received signals from the transducer to differential Q baseband signals using the fourth set of quadrature phase carrier signals;
a differential multiplexer configured to combine the differential I and Q baseband signals and to provide the combined differential I and Q baseband signals to a low pass filter that is configured to provide the filtered signals to the plurality of analog baseband and ADC pairs.

11. The hardware accelerator according to claim 10, whereby each IQ demodulator further comprises a low noise amplifier (LNA) that is provided between and output of the transducer and the inputs of the first and second double-balanced mixers.

12. The hardware accelerator according to claim 2, whereby the plurality of analog baseband and ADC pairs comprises a N number of analog baseband and ADC pairs and the array of receiver pixels comprises a N×N array of receiver pixels,
whereby each row of the N×N array of receiver pixels are connected to one of the N number of analog baseband and ADC pairs, and the controller being configured to employ a time multiplexing technique to control the conversion of the I and Q baseband signals received from the receiver pixels to digital representations by each of the N number of analog baseband and ADC pairs.

13. The hardware accelerator according to claim 1, whereby the ultrasonic waves received from the lens by the array of receiver pixels comprises Fourier transform waves formed when ultrasonic waves transmitted from the transmitter superimposed at the lens constructively and destructively.

14. A method for performing two-dimensional discrete Fourier transformation using a hardware accelerator that comprises of an ultrasonic transmitter, an ultrasonic receiver and a lens provided between the ultrasonic transmitter and the ultrasonic receiver, the method comprising:
receiving, using the ultrasonic transmitter, input and control signals;
receiving and storing, using the ultrasonic transmitter, input signals from the input data interface block and selectively providing, based on the control signals, the input signals to an array of transmitter pixels, whereby each transmitter pixel comprises a I path modulation block that is provided with a first set of quadrature phase carrier signals, and a Q path modulation block that is provided with a second set of quadrature phase carrier signals;
transmitting to the lens, using the array of transmitter pixels, ultrasonic waves generated by the I and Q path modulation blocks based on the input signals and the first and second sets of quadrature phase carrier signals;
down-converting, using an array of receiver pixels provided within the ultrasonic receiver, ultrasonic waves received from the lens to I and Q baseband signals based on third and fourth sets of quadrature phase carrier signals, whereby each receiver pixel comprises an IQ demodulator that is provided with the third and the fourth set of quadrature phase carrier signals;
converting, using the ultrasonic receiver, the I and Q baseband signals received from the receiver pixels to digital representations.

15. The method according to claim 14, whereby the method further comprises:
delaying, using the ultrasonic receiver, the down conversion of the ultrasonic waves by the array of receiver pixels by a diagonal propagation delay t_{prop_DL} whereby the diagonal propagation delay t_{prop_DL} is computed based on a diagonal length between the array of transmitter pixels and the array of receiver pixels and a speed of the ultrasonic waves traveling between the ultrasonic transmitter and ultrasonic receiver.

16. The method according to claim 14, whereby the method further comprises:
generating, using a clock generator that is communicatively connected to the ultrasonic transmitter and receiver, the first, second, third and fourth sets of quadrature phase carrier signals such that the first set of quadrature phase carrier signals is in-phase with the third set of quadrature phase carrier signals and the second set of quadrature phase carrier signals is in-phase with the fourth set of quadrature phase carrier signals.

17. The method according to claim 14, whereby each I path modulation block comprises a multiplexer, an I-driver and a transducer, the method comprising the steps of:
receiving, using the multiplexer, the first set of quadrature phase carrier signals and the input signal;
generating, using the I-driver, a modulated signal based on the input signal and the first set of quadrature phase carrier signals received from the multiplexer; and
generating and transmitting, using the transducer, ultrasonic waves based on the modulated signal generated by the I-driver.

18. The method according to claim 14, whereby each Q path modulation block comprises a multiplexer, a Q-driver and a transducer, the method comprising the steps of:
receiving, using the multiplexer, the second set of quadrature phase carrier signals and the input signal;
generating, using the Q-driver, a modulated signal based on the input signal and the second set of quadrature phase carrier signals received from the multiplexer; and
generating and transmitting, using the transducer, ultrasonic waves based on the modulated signal generated by the Q-driver.

19. The method according to claim 14, whereby each IQ demodulator comprises a transducer, a first and a second double-balanced mixer and a differential multiplexer, the method comprising the steps of:
receiving, using the transducer, ultrasonic waves from the lens and converting the ultrasonic waves to received signals;
down-converting, using the first double-balanced mixer, the received signals from the transducer to differential I baseband signals using the third set of quadrature phase carrier signals;
down-converting, using the second double-balanced mixer, the received signals from the transducer to differential Q baseband signals using the fourth set of quadrature phase carrier signals;
combining, using the differential multiplexer, the differential I and Q baseband signals and providing the combined differential I and Q baseband signals to a low pass filter; and
providing, using the low pass filter, the filtered signals to the plurality of analog baseband and ADC pairs.

20. A two-dimensional discrete Fourier transform sub-system comprising:
a transmitter block comprising:
an input data interface block configured to receive input and control signals;
a memory module configured to receive and store input signals from the input data interface block and based on the control signals, to selectively provide the input signals to an array of transmitter pixels,
whereby each transmitter pixel comprises a I path modulation block that is provided with a first set of quadrature phase carrier signals, and a Q path modulation block that is provided with a second set of quadrature phase carrier signals, and
whereby the array of transmitter pixels is configured to transmit to a lens provided between the transmitter block and a receiver block, ultrasonic waves generated by the I and Q path modulation blocks based on the input signals and the first and second sets of quadrature phase carrier signals;
the receiver block comprising:
an array of receiver pixels, whereby each receiver pixel comprises an IQ demodulator that is provided with a third and a fourth set of quadrature phase carrier signals, and whereby each receiver pixel is configured to use the IQ demodulator in each receiver pixel to down convert ultrasonic waves received from the lens to I and Q baseband signals based on the third and fourth sets of quadrature phase carrier signals;
a plurality of analog baseband and analog-to-digital converter (ADC) pairs configured to convert the I and Q baseband signals received from the receiver pixels to digital representations.
